(19) United States
(12) Patent Application Publication
(10) Pub. No.: US 2008/0210679 A1
(43) Pub. Date: Sep. 4, 2008

(54) Panel Heating Device

(75) Inventors: Heinz Peter Raidt, Dortmund (DE); Jorn Schroer, Herdecke (DE)

Correspondence Address: Jason H. Vick;Sheridan Ross, PC, Suite # 1200, 1560 Broadway, Denver, CO, 80202, US

(73) Assignee: EWALD DORKEN AG, HERDECKE (DE)

(21) Appl. No.: 11/909,633

(22) PCT Filed: Mar. 31, 2006
(86) PCT No.: PCT/EP2006/002920

§ 371 Date: Sep. 25, 2007

(30) Foreign Application Priority Data
Mar. 31, 2005 (DE) 10 2005 015 051.9

(51) Int. Cl. H05B 3/36; H05B 1/00

(52) U.S. Cl. 219/213; 219/528; 219/522

(57) ABSTRACT

The invention relates to a panel heating device (1) for placing in the floor area, comprising an electrically conductive layer and electrical supply lines. In order to provide a floor heating system having a low overall height while simultaneously damping noises, the invention provides that at least one sound-damping layer (7) is provided.

The invention relates to a panel heating device for placement in the area of floors, with an electrically conductive layer, another first layer and electrical supply lines.

In order to heat living spaces, heaters are commonly used. Whereas radiators were predominantly set up in the rooms to be heated in the past, today heating is increasingly being provided via floor heating as well. The use of panel or resistance heating systems, among other things, is known for this purpose. Familiar applications include mats with tubular-shaped resistance cables attached on them. These are embedded into the flooring, with a relatively large amount of flooring material being required for the embedding. Moreover, it is known from practical experience that, especially in older constructions, comfort is impaired as a result of walking noise when there is no floating flooring. What is more, particularly with hard coverings, even ones that are installed in a floating manner, problems with walking noise occur. In order to avoid such problems, it is a known practice to use acoustically insulating layers which are then disposed underneath the floor covering. If panel heaters embedded in the flooring are used in such floors to heat the floor, it becomes apparent that the degree of efficacy of these heaters is comparably low.

It is therefore the object of the present invention to make available a panel heater of the type mentioned at the outset in which the aforementioned disadvantages do not occur.

The aforementioned object is achieved according to the invention in a panel heating device of the type mentioned at the outset essentially in that at least one acoustically insulating layer is provided. The panel heating device according to the invention for placement in the floor area therefore has a double function, namely an acoustic insulation function in addition to the heating function. Due to the fact that the acoustically insulating layer is an integral component of the panel heating device, it is no longer necessary to provide a further acoustically insulating layer underneath the covering or the flooring. The panel heating device according to the invention can be laid directly onto the flooring followed by the floor covering on top of the panel heating device, resulting in a very simple layered construction. Since the panel heating device according to the invention is not embedded into the flooring, but rather can be placed onto the flooring with the acoustically insulating layer, it also exhibits a high degrees of efficacy with respect to the heat output.

In principle, any material known for that purpose can be used as an acoustically insulating material of the acoustically insulating layer, for example voluminous fiber material, mineral wool, foamed material and/or cork material. The use of composite materials such as carpet material, for example, or even combinations of the aforementioned materials are also readily possible. In order to produce a good acoustic insulation function, the thickness of the acoustically insulating layer should also be several times greater than the thickness of the electrically conductive layer which, in turn, can be comparable small. Depending on the insulating material and its thickness, a reduction in the walking noise of at least 10 dB can be achieved. In certain materials and thicknesses, the walking noise reduction was up to 26 dB.

In experiments that have been carried out, it has been determined that especially good acoustic insulation values result if the acoustically insulating layer consists of fleece and, particularly, plastic fleece, preferably made of polypropylene. Here, the weight per unit area should be greater than 50 g/m² and particularly between 100 g/m² and 500 g/m². In materials with weights per unit area of between 100 g/m² and 150 g/m², the reduction in walking noise was between 18 dB and 22 dB. By contrast, the walking noise was more than 3 dB higher, in part even up to 10 dB higher with thin laminate floors without an acoustically insulating layer than in commensurate floors with the panel heating device according to the invention. Moreover, the acoustically insulating layer can be a heavy foil. One sample embodiment provides for the use of a heavy foil with a weight per unit area of approx. 6 kg/m² made of 85 wt. % barium sulfate and 15 wt. % binding agent. A further acoustically insulating layer can also be optionally provided, for example a crosslinked polyethylene foam with a thickness of approx. 1 mm and a density of approx. 90 kg/m³.

It is also advantageous if, in addition to the acoustically insulating layer, at least one first layer made of an electrically insulating and liquid-tight material is provided. Through the use of at least one electrically insulating and liquid-tight layer, the panel heating device according to the invention offers the additional advantage that it is not possible for water to pass through the panel heater. This results in a seal on the plane.

It is particularly advantageous that, in addition to the first layer, another second layer made of an electrically insulating and liquid-tight material is provided, with the electrically conductive layer and the electrical supply lines being disposed between the first layer and the second layer. This produces a composite or layered material which carries out several functions simultaneously. The selection of the material for the first and second layers yields not only an electrical insulation, but also a reliable liquid, moisture, and water seal in the plane at the same time. Through the electrical insulation of the electrically conductive layer and the supply lines, the panel heater according to the invention can also be used in living areas in which routine penetration of moisture can be expected, such as in bathrooms, for example. Even if the panel heater according to the invention comes into contact on its outside with moisture, its function is not impaired as a result. The occurrence of fault currents need not be feared.

Particularly suited as a material for the first and/or the second layer are plastics, preferably polyolefins, polyester, polyurethane, and PVC. Polyethylene or polypropylene is especially preferred. It goes without saying that the plastics used can contain additives such as stabilizers, metal deactivators, crosslinking agents, colorants, fillers, strengtheners, and the like.

The first later and/or the other second layer can be designed as a heat-insulating layer or be joined to at least one heat-insulating layer. The heat-insulating layer can consist of polyurethane, polyisocyanurate, expanded polystyrene, foamed polystyrene, mineral wool, fiberglass, hemp, sheep's wool, or (recycled) cellulose plates. In this context, it is also possible to apply the heat-insulating layer subsequently by means of laminating with an adhesive. Furthermore, an extrusion coating can be provided, for example during the manufacture of the other first layer. It is otherwise possible to fasten the other first layer and/or the other second layer reactively or physically during the manufacture of the insulating layer, e.g. through attachment/fastening of a fiber/floc mixture using resins, or during the physical foaming of expanded or foamed polystyrene or during the reactive foaming of polyurethane or polyisocyanurate. Depending on its composition, the heat-insulating layer can be used as a further insulating of water-tight layer or even as an acoustically insulating layer. Preferably, the heat-insulating layer can have a thickness of from 5 mm up to greater than 100 mm, particularly of 20 mm. One sample embodiment makes the provision that, during manufacture, a polyurethane ribbon foam (already in itself known) made of diisocyanate, polyol and penthane as a heat-insulating layer, a panel heating device with an electrically conductive layer is fed to another first layer and electrical supply lines, so that the electrically conductive layer is facing toward the foam. In so doing, the reaction mixture can be poured onto the panel heating device, or it can form the upper boundary against which foaming is performed. Even the ribbon foam as such can form the other first layer. In addition, it is possible to affix the electrically conductive layer, the other first layer and the electrical supply lines to a vacuum insulating element.

In an alternative embodiment, a provision can be made that the first layer and/or the second layer consist of concrete or that the first layer and/or the second layer are joined with a concrete layer. Here, a provision can be made to insert the panel heating device into a formwork, for example on site or during the manufacture of finished elements at the factory. One sample embodiment makes the provision that a formwork for the creation of a concrete wall is built up, with the panel heating device being fastened to an electrically conductive layer, another first layer and electrical supply lines in the formwork on what is to be the visible side, so that the electrically conductive layer is oriented toward the concrete. Subsequently, the formwork is poured out in the familiar manner.

Particularly when using polypropylene but also when using other polymer materials, it is possible to design the layered composite of the panel heating device as a vapor seal with a vapor permeability per DIN 52615 (23/0→85) of less than 10 g/(m²×24 h), preferably less than 5 g/(m²×24 h), and particularly less than 1 g/(m²×24 h). Consequently, the first and/or second layer assumes a further function in addition to the aforementioned insulating and sealing functions by means of which it is ensured that water vapor from the subsurface does not penetrate into the coat applied to the panel heater and impair the coating or its connection to the panel heating device, or does so only to a very small extent, or that moisture [does not] penetrate into the construction underlying the panel heater in the bath area, for example.

Since the panel heater is, after all, a mass-produced product, it is expedient for technical manufacture-related reasons to produce the panel heater as sheeting. In particular, a provision can then be made in this context that the first layer and the second layer are joined to each other at the mutually facing sides, i.e. the longitudinal edges, in a liquid-tight and, particularly, a vapor-tight manner along the edge, so that a panel composite of several sheets joined together is created which is insulated and liquid-tight overall. In order to achieve such a panel composite, several possibilities can be provided for. In one alternative, a provision is made that the width of the electrically conductive layer is smaller than the respective width of the first and the second layer, so that, in the end, an overhang is produced on both sides over which the two layers can be joined tightly together. The edge produced in this context should have such a length on both sides that a liquid-tight, particularly vapor-tight, joint is possible in the installed state to an edge of the neighboring panel heater. In order to ensure a reliable joint here, the edge should be greater than 1 cm on each side. A length of greater than 5 cm is technically no longer necessary. In an alternative, the individual sheets can be laid edge to edge such that the edges abut. A sealing band can then be applied, particularly welded on or glued on. In principle, it is also possible to overlap the individual sheets in the edge area and join them together.

The formation of the panel heater as sheeting also results in additional advantages. The panel heater according to the invention can be adapted very easily to the local installation conditions. The respective sheets can be shortened at will and, if necessary, be cut into or cut out accordingly. An adaptation to uneven subsurfaces is also easily possible due to the layered material used. Here, at least one compensation layer can be optionally provided for any unevenness of the subsurface; an acoustic protection layer can optionally also be used to compensate for unevenness. As a result, the panel heater according to the invention offers an enormous amount of flexibility. Furthermore, sheeting offers the advantage that it can be rolled up, which makes transport, storage and handling considerably easier.

Since the panel heater according to the invention is preferably manufactured as sheeting, it is advantageous if the first layer as well as the second layer are designed as a coating applied to the electrically conductive layer with a weight per unit area of between 20 g/m² and 1000 g/m², preferably between 50 g/m² and 250 g/m². It of course goes without saying that it is also possible in principle to design the first and/or second layer as a foil sheet. The composite material consisting of the first and the second layer as well as the electrically conductive layer with the supply lines thus has a decidedly low structural profile, which offers enormous installation advantages, and not only in new constructions. In addition, the panel heating device according to the invention can be easily provided retroactively, for example during a renovation, particularly in older buildings, which is made easily possible precisely due to the low structural profile.

To improve the electrical safety, durability and, if applicable, the undercoat characteristics of the panel heating device according to the invention, for certain applications it may prove expedient to form the insulating layer in several layers, for example through coextrusion, which is to say that at least one additional insulating layer is applied to the first layer and/or the second layer.

It is also expedient to dispose the acoustically insulating layer on the side of the panel heating device facing the floor so that the acoustically insulating layer lies on the flooring. This arrangement of the acoustically insulating layer is expedient because the heat conductance from the electrically conductive layer to the floor covering is not impaired as a result. A further advantage of this arrangement lies in the fact that, in the installed state, the acoustically insulating layer, by virtue of its inherent elasticity, presses the electrically conductive layer against the lower side of the floor covering layer, which favors a good heat transfer.

In order to obtain good heating characteristics in addition to a good bond to the first and second layer, the electrically conductive layer should contain conductive fibers such as carbon fibers, for example, over the surface to be heated and, particularly, be designed in the manner of a fleece. In addition, the use of an electrically conductive layer offers the substantial advantage that perforations, incisions and the like do not lead to the functional failure of the panel heating device. It is economically advantageous and, if applicable, advantageous for the adjustment of conductivity that a mixture with glass fibers and/or other fibers be used. It is particularly expedient here if the electrically conductive layer has between 50% and 90% glass fibers and 10% to 50% carbon fibers. The weight per unit area of the electrically conductive layer should be between 5 g/m² and 150 g/m² and particularly between 10 g/m² and 40 g/m², i.e. be lower than the weight per unit area of the first and the second layer, which contributes to the very low structural profile of the panel heater according to the invention.

In order to prevent delamination or detachment from the subsurface, the electrically conductive layer can have a plurality of preferably regularly arranged openings, where the surface proportion of the openings on the base surface of the electrically conductive layer can preferably be between 5% to 20%, in particular about 10%. Through the open areas in the electrically conductive layer, an embedding of the first layer and/or the second layer into the open areas can be achieved during the manufacture of the panel heating device according to the invention, wherein the openings can, particularly, be continuous, which allows for the penetration of the conductive layer from both sides. In one sample embodiment, a provision is made that holes with a diameter of 2 mm to 6 mm, preferably of 4 mm, are punched into the electrically conductive layer in regular intervals so that the remaining non-perforated portion of the surface is at least 80%, preferably about 90%.

For example, the electrically conductive layer can be obtained through physical vacuum deposition of metal or a metal alloy on the first layer, where the first layer can be a foil, a fleece, or a woven fabric. Moreover, graphite foils can be used as the electrically conductive layer or the electrically conductive layer can be obtained by coating the first layer with graphite and a binding agent. In this context, conductive soot can also be used in place of graphite. The first layer is preferably a fleece carrier. In one sample embodiment for the physical vacuum deposition of metals on a foil, a provision is made to sputter a polyester foil having a thickness of approx. 50 μm with titanium particles having a size of approx. 300 nm.

Since the electrically conductive layer is generally relatively thin and can hardly withstand tensile forces, a provision can be made that the electrically conductive layer has at least one further layer which has the function, for example, of a supporting layer. The further layer does not necessarily need to be electrically conductive. The electrically conductive layer itself can thus be designed as a layered material having several layers.

Instead of or in addition to the aforementioned further layer, a reinforcement layer, preferably a lattice-like one, can be provided on the panel heating device. In the layered composite of the panel heating device, this reinforcement layer can be provided anywhere, in principle. This layer essentially serves to withstand tensile forces in order to protect the electrically conductive layer. Another advantage of this layer lies in the fact that it serves to improve the flatness of the panel heating device.

In particular, if the electrically conductive layer is designed as a fleece, it is expedient to apply the first and the second layer as well onto the electrically conductive layer through extrusion coating. The result is not only a reliable, smooth joint to the electrically conductive layer[, but,] in addition, the electrical supply lines are also affixed onto the electrically conductive layer. In the invention, it is thus not necessary to attach the supply lines in any further manner to the electrically conductive layer, for example by means of an additional adhesive bond.

In order to obtain an especially good fixing of the supply lines on the electrically conductive layer by means of the extrusion coating, the supply lines should not be disposed directly at the edges or longitudinal edges of the electrically conductive layer, but rather at a prescribed distance, so that a joint can still be formed in this area between the extruded material and the electrically conductive layer. To achieve a reliable bond, the distance should be greater than 2 mm.

In addition, the electrical connection is set up such that two parallel supply lines are provided which are disposed spaced apart from each other in the areas of longitudinal edges of the electrically conductive layer at the aforementioned prescribed distance from the longitudinal edge. The supply lines should consist of highly conductive material such as copper, for example, or a copper alloy, in order to ensure a uniform heating of the heater. In order to have as small a thickness as possible with supply lines that are to be applied separately, it is expedient to design the supply lines in the manner of strips and otherwise in the manner of netting. Netting has the substantial advantage that longitudinal changes during operation are easily possible and the heater is particularly flexible.

In principle, it is also possible to work the electrical supply lines into the electrically conductive layer if it is designed to be fibrous or fleece-like. In this case, fibers made of a material with high conductivity with respect to the conductivity of the conductive layer are put in place in both lateral edge areas of the layered sheet. In so doing, copper fibers could be provided, for example. By virtue of the quantity or concentration of the fibers having higher electrical conductivity provided there, supply lines can be implemented which run longitudinally within the electrically conductive fleece-like or fibrous material. The preceding feature also has proprietary inventive significance.

Incidentally, it can prove expedient in the case of a fleece-like or fibrous material if electrically conductive fibers are not provided over the entire surface in the area to be heated in the sheeting, but rather are only provided in electrically conductive fibers running transversely in a sectional manner. The spacing of neighboring electrically conductive fiber areas, in turn, depends on the respective application. The fiber areas between neighboring conductive fiber areas are not electrically conductive. Such an arrangement is relatively economical, since the comparably expensive electrically conductive fiber material is not used over the entire surface.

Moreover, it is possible to design the electrically conductive layer in the manner of a weave or a clutch. In this case, a plurality of transversely running weft threads made of electrically conductive material are still provided. It is self-evident that non-conductive weft threads can also be provided in addition to the electrically conductive weft threads. The distance of the electrically conductive weft threads from each other depends on the respective application. For use in the floor area, a heat distribution on the respective covering that is as uniform as possible is desired, whereas a highly uniform heat distribution is not essential for use in the wall or ceiling area. The weft threads can each be contacted in the lateral edge area through electrical supply lines to be applied separately. However, it is particularly advantageous to provide electrically conductive edge warp threads in the respective edge area, which contact the electrically conductive weft threads. The remaining warp threads running longitudinally are not electrically conductive.

In principle, it is possible to provide, in addition to the electrically conductive layer, at least one other electrically conductive layer which is electrically isolated from the aforementioned conductive layer. This other conductive layer is not connected to the electrical supply lines, but rather is optionally grounded, resulting in a protective function from radiation of electrical and electromagnetic fields.

In principle, it may even prove expedient to design the panel heating device according to the invention itself as a floor covering. In this case, the outermost layer facing the room should be a thick and resistant coating material or a covering that can be walked on. In this case, incidentally, it could also be expedient to apply a structure and/or a decorative coating to the outer room side of the outermost layer. Moreover, a carpet flooring can also be provided as the outer layer which is then designed in a single piece with the heating device according to the invention.

Depending on the application, it may be expedient to join the panel heating device to the covering to be placed on top thereof and/or to the subsurface. To this end, the outer side of the panel heating device facing the room or the floor can either be provided with a gluing or adhesion promoter or consist of a fleece-like, fibrous or porous material and/or have undercuts and/or protrusions so that an adhesive bridge is produced into which an adhesive, for example, can penetrate well and hold accordingly well. However, in principle, it is also possible to provide no adhesive on the upper side of the panel heating device facing the room. In principle, this is also possible on the lower floor side. Particularly, if the acoustically insulating layer consists of fleece, this layer can not only assume the acoustic insulation function but can also serve as an adhesive bridge for bonding of the underside to the subsurface at the same time.

Note that all of the aforementioned ranges comprise the values lying within the respective range even if they are not listed individually.

Moreover, the present invention also relates to a method for the manufacture of a panel heating device of the type named at the outset, with the constructive features being implemented accordingly using the method. The individual features shall not be repeated here. What is more, the invention relates to a method for the installation of a panel heater of the aforementioned type. More detail is provided about the individual methods in connection with the sample embodiments.

One possible area of application of the panel heating device according to the invention is represented by the heating of parallel gutters, particularly in the roof area. In the window area, the panel heating device according to the invention can be provided to prevent the formation of condensate, where the panel heating device can be disposed under the window opening on the wall or under the window sill. It is also possible to use the panel heating device according to the invention directly as a window sill in the form of a composite plate.

In the following, the invention is described in further detail on the basis of the drawing.

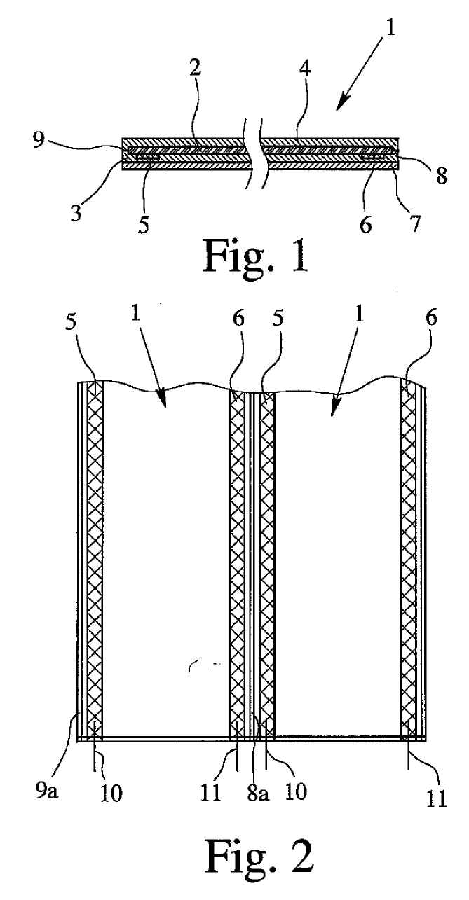

FIG. 1 shows a schematic cross-section of a panel heating device according to the invention, and

FIG. 2 shows a top view of a portion of an installed panel heater with several sheets of panel heating devices, and

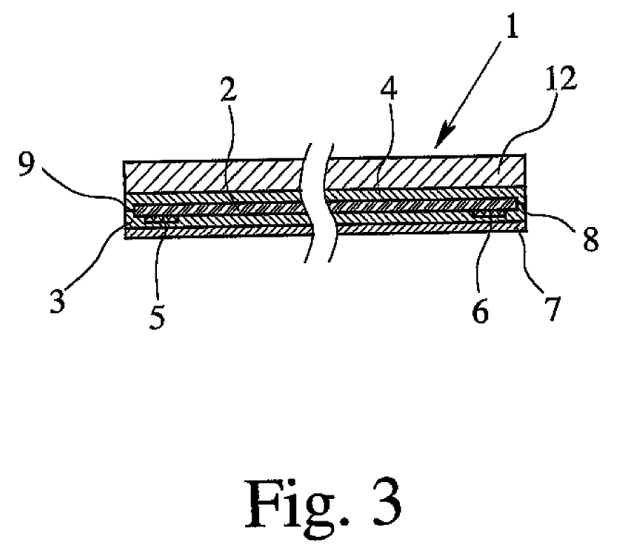

FIG. 3 shows a schematic cross-section of a panel heating device according to the invention with floor covering.

Represented schematically in FIG. 1 is a panel heating device 1. The panel heating device 1 has an electrically conductive layer 2 and a plurality of other layers. Immediately neighboring the electrically conductive layer 2 is a further first layer 3, which is provided on the lower side of the electrically conductive layer 2. Provided on the upper side as another layer is a second layer 4. Moreover, the panel heating device 1 has electrical supply lines 5, 6, which contact the layer 2. The electrically conductive layer 2 and the electrical supply lines 5, 6 are disposed between the first layer 3 and the second layer 4.

A lower acoustically insulating layer 7 is located adjacent to the first layer 3. The acoustically insulating layer consists predominantly of a needled spun fleece made of polypropylene with a weight per unit area of 120 g/m². By contrast, the first layer 3 and the second layer 4 consist of an electrically conductive and liquid-tight material. In principle, this material can be any type of plastic. In the sample embodiment, it is polypropylene, which also carries out the function of a vapor seal here with a vapor permeability of 0.88 g/(m²×24 h) (per DIN 52615).

The panel heating device 1 is a layer material which, as follows particularly from FIG. 2, is manufactured as sheeting.

As also follows from the figures, the first layer 3 and the second layer 4 are joined together on their facing sides on their edges by means of a corresponding joint 8, 9. The joints 8, 9 are each liquid-tight and, particularly, vapor-tight, so that, for one thing, liquid is not able to get to the electrically conductive layer 2 and, for the other, it is not possible for vapor to pass through an installed panel heater as depicted in FIG. 2.

As a result of the joints 8, 9, a protruding edge 8a, 9a is respectively formed on the two longitudinal sides of the panel heater. Here, the edge should have a length such that a liquid-tight and, particularly, vapor-tight joint is possible in the installed state with an edge of a neighboring panel heating device 1. In the depicted sample embodiments, the protruding edge 8a, 9a has a length of about 2 cm. When two panel heating devices 1 lie next to each other, an overlapping then results which is sufficient to achieve a continuous longitudinal joint between these edges.

Here, the electrically conductive layer 2 is a heatable fleece with a weight per unit area of 20 g/m² which consists of 80% glass fibers and 20% carbon fibers and a binding agent. The width of this sheet is about 1 m. In principle, it is also possible that the electrically conductive layer has an additional, optionally even not electrically conductive carrier layer. The first layer 3 is applied by means of extrusion coating with interposition of the electrical supply lines 5, 6 onto the electrically conductive layer 2, so that the supply lines 5, 6 are affixed onto the electrically conductive layer 2 such that they contact this. The second layer 4 is also applied onto the electrically conductive layer by means of extrusion coating. The first and the second layer 3, 4 have a weight per unit area of about 100 g/m² and each has a width of about 1.04 m. The layers 3, 4 protrude on both sides over the electrically conductive layer 2, so that the joints 8, 9 can be implemented.

Two parallel electrical supply lines 5, 6 are provided for the electrically conductive layer 2. Each of the supply lines 5, 6 is disposed in the area of a longitudinal edge of the electrically conductive layer 2 at a distance of about 0.5 cm from the longitudinal edges. The supply lines 5, 6 themselves consist of copper or a copper alloy, are ribbon-shaped, and are designed as a netting. Here, the width of the supply lines is 5 mm.

In the depicted sample embodiment, the acoustically insulating layer 7 not only has an acoustic insulation function but can also serve as an adhesive bridge for secure bonding to the subsurface and, furthermore, can be used for mechanical decoupling. Mechanical decoupling means that levels are provided which can be moved relative to each other, hence readily enabling a change in length or a shifting of the panel heating device 1 with respect to the subsurface or the covering. This decoupling is produced, for example, in that, although an adhesive penetrates to a sufficient depth into the acoustically insulating layer 7 to produce a solid bond, a sufficiently thick fibrous area remains in order to be able to carry out the mechanical decoupling function as well as the acoustic insulation function.

Depicted in FIG. 3 is a floor covering 12 with a panel heating device 1. The floor covering 12 can be parquet or laminate, for example. In the sample embodiment depicted in FIG. 3, the floor covering 12 is already designed in a single piece with the panel heating device 1. The panel heating device 1 is provided on the lower side of the floor covering 12 and, particularly, with no hollow space, or is connected thereto such that a good heat conductance from the electrically conductive layer 2 into the covering 12 results.

The manufacture of the panel heating device 1 (not depicted separately) proceeds such that the electrically conductive layer 2 is extrusion-coated on one side in a first work step. At the same time, the outer layer is conveyed on the other side to the polypropylene melt. Parallel to this or in a second work step, the previously described first work step is carried out analogously. Here, the two supply lines 5, 6 also run in. During the extrusion coating of the lower side of the electrically conductive layer 2 with interposition of the supply lines 5, 6, a fixation of the supply lines 5, 6 on the electrically conductive layer 2 occurs with simultaneous contacting without further bonding agents or joints being provided between the supply lines 5, 6 and the electrically conductive layer 2. This good composite adhesion occurs because, during the extrusion coating, the melts of the layers 3 and 4 penetrate into the pores of the conductive layers 2 and the supply lines 5, 6 or even penetrate through them in part.

The installation of a panel heating device 1 of the aforementioned type is performed such that a strip of the panel heating device 1 is cut to length from the sheeting for the prescribed application, i.e. it is cut off. This finished strip is then placed with the acoustically insulating layer 7 downward onto the subsurface. However, this is not absolutely necessary. In order to electrically connect the panel heating device 1, the supply lines 5, 6 are then exposed in areas and electrically connected to electric supply lines 11, 12. Subsequently, the exposed areas are insulated and sealed.

In order to provide for complete surface heating in the respective room, several strips are disposed next to each other which are connected, particularly welded or glued, to each other at their edges. Moreover, the strips are sealed off along their cut-off front side accordingly. This can also take place directly by means of appropriate adhesion or sealing elements that are to be applied separately, which are applied on the end side and then joined with a layered composite.

After the complete installation of the panel heater, the floor covering is placed onto the upper layer 4 such that it is as free of hollow spaces as possible. An arrangement that is at least substantially free of hollow spaces results from the inherent flexibility of the acoustically insulating layer 7, which exerts a counterforce to the force of the weight of the floor covering and presses the layer 4 against the underside of the floor covering. Moreover, it goes without saying that it is also possible in principle to adhere the panel heating device 1 to the floor covering. Finally, an arrangement such as that depicted in FIG. 3 results after the installation of the floor covering.

If the floor covering 12 is designed as a single piece with the panel heating device 1, a direct installation of the individual floor covering elements onto the subsurface can occur. In order to electrically connect the panel heating device 1, each floor covering element or groups of joined floor covering elements can be electrically connected. In principle, however, it is also possible to join neighboring floor covering elements to each other electrically via appropriate connection contacts during installation.

1-38. (canceled)

39. Panel heating device for arrangement in the area of floors, with an electrically conductive layer and with electrical supply lines, wherein at least one acoustically insulating layer is provided.

40. Panel heating device as set forth in claim 39, wherein the acoustically insulating layer has fiber material, mineral wool, foamed material and/or cork material and that, preferably, the thickness of the acoustically insulating layer is several times greater than the thickness of the electrically conductive layer.

41. Panel heating device as set forth in claim 39, wherein a heavy foil is provided as an acoustically insulating layer.

42. Panel heating device as set forth in claim 39, wherein at least one first layer made of an electrically insulating and liquid-tight material is provided, that a further second layer made of an electrically insulating and liquid-tight material is provided and that the electrically conductive layer and the electrical supply lines are disposed between the first layer and the second layer.

43. Panel heating device as set forth in claim 39, wherein the first layer and/or the second layer consist of plastic, preferably polyolefins, polyester, polyurethane or PVC and particularly of polyethylene or polypropylene and/or that the first layer and/or the second layer are designed as a heat-insulating layer and consist of polyurethane, polyisocyanurate, expanded polystyrene, foamed polystyrene, mineral wool, fiberglass, hemp, sheep's wool or (recycled) cellulose plates or that the first layer and/or the second layer are joined to at least one heat-insulating layer made of polyurethane, polyisocyanurate, expanded polystyrene, foamed polystyrene, mineral wool, fiberglass, hemp, sheep's wool or (recycled) cellulose plates.

44. Panel heating device as set forth in claim 39, wherein the first layer and/or the second layer consist of concrete or that the first layer and/or the second layer are joined to a concrete layer.

45. Panel heating device as set forth in claim 39, wherein the first layer and the second layer are joined on at least two opposing sides on the edge in a liquid-tight, particularly vapor-tight, manner.

46. Panel heating device as set forth in claim 39, wherein at least one other electrical insulating and liquid-tight layer is applied to the first layer and/or the second layer.

47. Panel heating device as set forth in claim 39, wherein the electrically conductive layer has a plurality of preferably regularly arranged openings wherein, preferably, the surface area proportion of the openings on the base surface of the electrically conductive layer is between 5% and 20%, particularly approx. 10%.

48. Panel heating device as set forth in claim 39, wherein longitudinally running fiber areas with fibers having an elevated conductivity are provided to form the supply lines in the edge area of the electrically conductive layer.

49. Panel heating device as set forth in claim 39, wherein the electrically conductive layer is designed in the manner of a weave or a clutch, that a plurality of transversely running weft threads are provided and that at least one electrically conductive edge warp thread, preferably a plurality of them, is provided.

50. Panel heating device as set forth in claim 39, wherein a reinforcement layer, particularly a lattice-like one, is provided to improve the flatness of the panel heating device and/or to withstand tensile forces in order to protect the electrically conductive layer.

51. Panel heating device as set forth in claim 39, wherein the first layer is applied by means of extrusion coating with interposition of the electrical supply lines onto the electrically conductive layer such that the supply lines are affixed onto the electrically conductive layer and/or that the second layer is applied by means of extrusion coating onto the electrically conductive layer.

52. Panel heating device as set forth in claim 39, wherein a structuring and/or a decorative lamination or coating and/or a covering that can be walked on is applied on the outer side of the panel heating device facing the room.

53. Panel heating device as set forth in claim 39, wherein the acoustically insulating layer is disposed on the side facing the floor.

54. Panel heating device as set forth in claim 39, wherein a decoupling within at least one layer or between two neighboring layers is provided for.

55. Floor covering, particularly parquet or laminate, with at least one panel heating device as set forth in claim 39.

56. Floor covering as set forth in claim 55, wherein the panel heating device is attached in a manner free of hollow space to the underside of the floor covering.

57. Method for the manufacture of a panel heating device as set forth in claim 39.
